(19) United States
(12) Patent Application Publication
(10) Pub. No.: US 2005/0193609 A1
(43) Pub. Date: Sep. 8, 2005

(54) Medical information patch

(76) Inventor: Janice B. Schwartz, San Francisco, CA (US)

Correspondence Address: Tianjun Hou;DORSEY & WHITNEY LLP, Suite 3400, 4 Embarcadero Center, San Francisco, CA, 94111, US

(21) Appl. No.: 11/067,096

(22) Filed: Feb. 25, 2005

Related U.S. Application Data
(60) Provisional application No. 60/548,024, filed on Feb. 27, 2004.

(51) Int. Cl. G09F 3/10

(52) U.S. Cl. 40/638

(57) ABSTRACT

A medical information patch 10 is provided, which comprises a substrate 12 having a first surface 14 printable with medical information and a second surface 16 comprising an adhesive 18 for adhering the patch 10 to the skin of a person. The substrate 12 is formed of materials that are suitable for printing with any indicia or text conveying medical information. The medical information patch 10 may comprise an emergency supply of a medicament, or a memory chip with personal medical information data stored therein, or a monitor device monitoring user's medical conditions.

### CROSS-REFERENCE TO RELATED APPLICATIONS

This application claims benefit under 35 U.S.C. § 119(e) to application Ser. No. 60/548,024, filed Feb. 27, 2004, the disclosure of which is incorporated herein by reference.

### FIELD

This invention relates generally to medical information carrying devices, and in particular, to medical information patches that can be attached to the user's skin utilizing adhesives.

### BACKGROUND

Medical or allergy information can be critical to a person's survival in medical emergencies. This is especially important when a person is unconscious or unable to communicate due to the person's medical condition, language, memory, or age. Information of contraindicated substances may also be needed before emergency medical personnel begin treatment of a person.

Medical information jewelry has been known and used to carry personal medical information. For example, a necklace or bracelet is imprinted with information indicating that the wearer suffers from a particular disease, for example, diabetes. Medical information jewelry is not universally accepted, however, since many people do not like the stigma associated with wearing a visible indicator signifying that the individual has a medical condition. Further, necklaces or bracelets may contain metals that are reactive and become eroded after a period of time.

There are known medical information cards printed with medical information. Problems of this technique are that the cards are subject to damage or loss due to fire, water or theft. Often times such Cards are carried away from the body, such as in a wallet or a purse. In situations of exercise or outdoor excursions, the card may be separated from the individual with the individual's wallet or purse, thus further increasing the chances of loss or damage.

Accordingly, there is a need for an improved device and method for carrying medical information.

### SUMMARY

The present invention provides medical information patches that can be worn by individuals in visibly concealed places, if desired, and that can be accessed by appropriate personnel in case of an emergency. In some embodiments, the medical information patch comprises a substrate having a first surface printed with medical information and a second surface comprising an adhesive for adhering the patch to the skin of a person. A release liner can be releasably secured to the second surface of the substrate to keep the second surface clean and the adhesive fresh when the medical information patch is not in use. Prior to use of the medical information patch, the release liner is removed, thereby uncovering the adhesive for adhering the patch to the person's skin. A non-transparent, semi-transparent or transparent protective cover may be secured to the first surface to cover the printed medical information.

The substrate is formed of materials that are suitable for printing with any indicia or text. The substrate can be formed of a flexible material for adjusting to the shape of the portion of the body to which it is adhered, and for accommodating active movement. The additional information can include virtually any type of information, and in some embodiments is specific to the wearer. For example, the additional information could include emergency contact information specific to the wearer, emergency instructions specific to the wearer, and/or genetic information specific to the wearer. Virtually any type of information that could be useful to the individual in an emergency situation could be included with the additional information.

In some embodiments, the medical information patch may comprise additional information contained on paper or computer-readable media disposed between the protective cover and the first surface of the substrate. The additional information can be emergency instructions specific for the person, or emergency contact information for the person.

In some embodiments, the medical information patch may comprise a supply of a medicament so that medical personnel may have immediate access to the medicament in a medical emergency.

In other embodiments, the medical information patch may comprise a monitor device for monitoring a wearer's medical condition(s) such as the blood oxygen level, blood glucose level, and the pulse rate and body temperature. When the monitor device detects an emergency medical situation, an emergency signal is generated to alert search or rescue services.

### BRIEF DESCRIPTION OF THE DRAWINGS

These and various other features and advantages of the present invention will become better understood upon reading of the following detailed description in conjunction with the accompanying drawings and the appended claims provided below, where:

FIG. 1 is a perspective view showing a medical information patch according to one embodiment of the present invention;

FIG. 2 is a perspective view showing a medical information patch with a release liner and a protective cover according to one embodiment of the present invention;

FIG. 3 is perspective view of an exemplary embodiment of a medical information patch that includes a pocket for carrying additional medical or other information; and

FIG. 4 shows various types of exemplary medical information that can be printed or otherwise carried by a medical information patch according to the present invention.

### DETAILED DESCRIPTION OF THE INVENTION

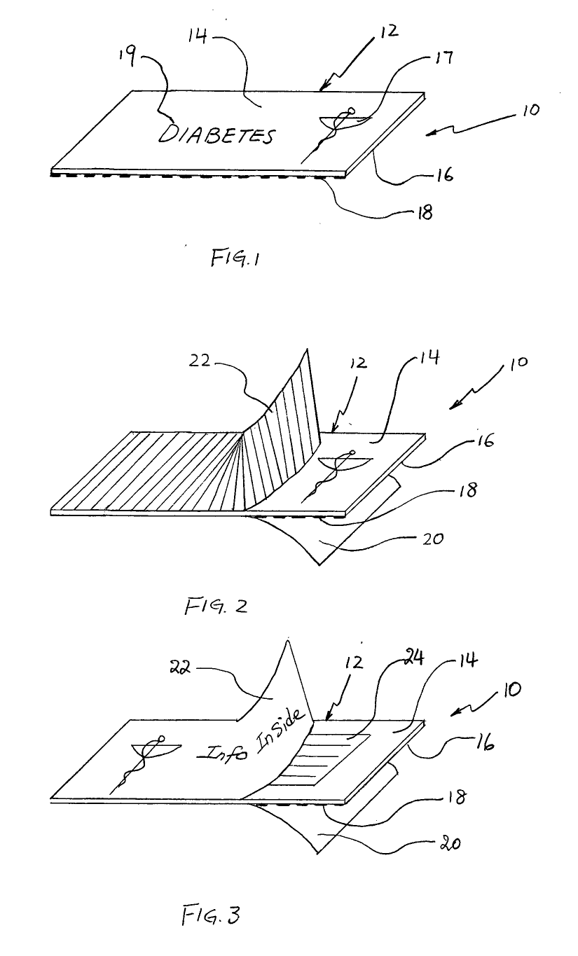

Referring to FIGS. 1 to 4, where like elements are designated by like references, exemplary embodiments of medical information patches will now be described. Referring to FIG. 1, exemplary medical information patch 10 comprises a substrate 12 having a first surface 14 and a second surface 16. The first surface 14 is printed with medical information. The information can be in the form of pictures, symbols such as a universal medical symbol 17, and/or text 19 in any language or languages. The text 19 may contain any general medical information such as “Allergy,” “No Peanuts,” and “Caution!” etc. The text 19 may also contain specific personal medical information including but not limited to, information indicating that the wearer suffers from a specific medical condition, such as diabetes, renal failure, organ transplant, dialysis, usage of an allergy to a medicament, such as, for example, anticoagulants, antiplatelet's, immunosuppressive's, protease inhibitors, etc., and/or advance directives of the wearer The second surface 16 is applied with an adhesive 18 for adhering the medical information patch 10 to the user's skin.

The substrate 12 can be formed of materials known in the art and commercially available. The materials forming of the substrate should be selected such that the substrate surface is printable with any indicia or text. Non-limiting Examples of suitable materials for the substrate 12 include polyurethane films, polyolefin films, polyvinylchloride films, ethylene vinyl acetate films, polyester fibers, polyamide fibers, etc. U.S. Pat. No. 6,747,183 describes various materials suitable for the substrate of the medical information patch of the present invention, the disclosure of which is incorporated herein by reference.

In one embodiment, the substrate 12 is formed of a flexible plastic film or fabric material for adjusting to the shape of the portion of the body to which the medical information patch 10 is adhered, such as the wearer's torso, wrist or arm, and for accommodating active movement. A flexible substrate provides comfort and fit when the medical information patch is attached to the user's skin.

In one embodiment, the substrate 12 is formed of a porous material or it can be perforated to allow perspiration to transmit through and evaporate.

Any adhesives known in the art and commercially available can be used in the medical information patch 10 of the present invention. The adhesives 18 can be pressure-sensitive adhesives. Non-limiting examples of suitable adhesives include those based on styrenic block copolymers, tackifying resins, ethylene copolymers. Suitable adhesives also include acrylic based, dextrin based, and urethane based adhesives as well as those based on natural and synthetic elastomers. U.S. Pat. No. 6,747,183 describes various adhesives suitable for the medical information patch of the present invention, the disclosure of which is incorporated herein by reference. In some embodiments, the adhesive is water-resistant so that the patch remains adhered to the individual when exposed to moisture, such as when the individual perspire, bathes, showers, etc. Suitable water-resistant adhesive are well-known in the are.

The adhesives 18 can be applied to the second surface 16 of the substrate 12 by any conventional means such as by spraying, coating, printing or other well-known methods. The amount of adhesive applied on the substrate is not critical. The only requirement is that an amount of adhesive be applied that is sufficient to the wearer's skin for a desired period of time.

A release liner 20 can be releasably secured to the second surface 16 of the substrate 12. When the medical information patch 10 is not in use, the release liner 20 covers the second surface 16 applied with adhesive 18 to keep the surface clean and the adhesive fresh. The release liner 20 can be formed of any flexible plastic film known in the art and commercially available. When the medical information patch 10 is in use, the release liner can be easily removed, thereby uncovering the adhesive 18 for adhering the patch 10 to the user's skin.

A protective cover 22 can be secured to the first surface 14 of the substrate 12. The protective cover 22 can be non-transparent or semi-transparent so that the medical information printed on the first surface 14 cannot be seen or clearly seen when covered by the protective cover 22. Alternatively, the protective 22 cover can be transparent so that the information printed on the first surface can be cleanly seen. The protective cover 22 can be formed of a flexible plastic film that is waterproof to protect the underneath printing from damage. The protective cover 22 can be secured to the first surface 14 in any conventional ways. In some embodiments the protective cover 22 is permanently attached to the first surface and covered to protect the medical information printed on the first-surface from damage from exposure to perspiration, environmental elements, etc. In other embodiments, the protective cover 22 can be releasably secured to the first surface 14 and can be separated from and reattached to the first surface 14 one or multiple times. In emergencies, medical personnel may peel back the protective cover 22 to obtain any medical information printed on the first surface. This is desirable when the medical information patch 10 is attached to an exposed area of a user such as a wrist and the user does not wish to reveal its medical information to others in non-emergency situations.

In one embodiment shown in FIG. 3, the protective cover 22 is printed with information. For instance, the protective cover 22 may be printed with indicia or text indicating that additional information 24 is provided under the cover 22 to direct medical personnel to the same. The additional information 24 can be the user's medical information, generic information, emergency contact information, and/or emergency instructions specific for the user. The additional information 24 can be printed on paper or computer-readable media.

In another embodiment, one or more printable sheets (not shown) can be placed between the first surface 14 of the substrate 12 and the protective cover 22. The one or more sheets may be detachable from the medical information patch 10 and then discarded. The one or more sheets may be blank, or pre-printed with any information.

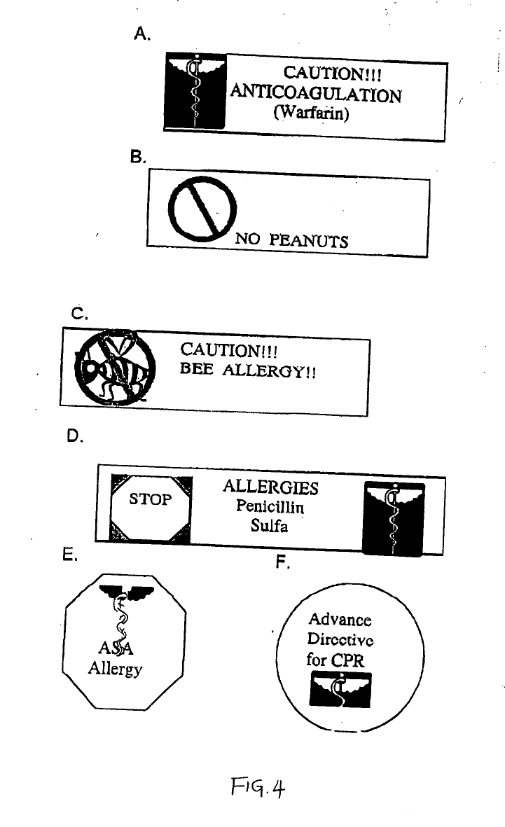

The present invention provides a simple, inexpensive, and disposable medical information patch that can be conveniently attached to and removed from the user's skin. The medical information patch can be applied to the user's skin for short or extended periods such as for days or weeks, which is ideal for travel, especially foreign travel, or hospitalization which requires short-term course of medications. For instance, the medical information patch of the present invention can be used during a patient's anticoagulation or antiplatelet therapy after procedures such as hip replacement or angioplasty. The medical information patch can be made flexible, which provides comfort and fit when it is in use. Advantageously, the medical information patch of the present invention can be attached to either exposed or non-exposed area to protect medical privacy of a user and facilitate usage. For use by children or cognitively impaired, the medical information patch can be applied to an area or a location that is inaccessible to them to ensure safety. The medical information patch can be formed in any size or shape for specific applications. For example, the patch can be conveniently formed in the shape of a circle, rectangular, or various other shapes, as shown in FIG. 4.

In some embodiments, the medical information patch 10 may include a supply of a patient's medicament (not shown). The medicament can be tablets, capsules or in any other forms and may be contained or incapsulated in a package that can be easily opened. For instance, the medicament can be incapsulated in a blister package having a rupturable metal foil bottom. The medicament supply package can be directly attached to the medical information patch. The medical information patch with a medicament supply is desirable especially in emergencies so that a user or medical personnel may have immediate access to the medicament.

In other embodiments, the medical information patch 10 of the present invention may comprise a memory chip (not shown) with personal medical information, genetic information or medical history data stored therein. The medical data stored in the memory chip is readable by an electronic reader. The memory chip can be contained in a package or locket that interfaces with an electronic reader. The package containing the memory chip can be directly attached to the medical information patch. The package exterior may contain indicia or text indicating a memory chip inside or medical information of a user.

In a further embodiment, the medical information patch 10 of the present invention may comprise a monitor device (not shown) for monitoring user's medical conditions, such as the blood oxygen level, blood glucose level, and the pulse rate and body temperature, etc. When the monitor device detects an emergency medical situation, an emergency signal is generated to alert search or rescue services. This is especially desirable when an individual is on an excursion, especially in remote areas, where either the heath of the individual or the environment creates a risk to the individual's survival.

The foregoing description of specific embodiments and examples of the invention have been presented for the purpose of illustration and description, and although the invention has been described and illustrated by certain of the preceding examples, it is not to be construed as being limited thereby. They are not intended to be exhaustive or to limit the invention to the precise forms disclosed, and many modifications, improvements and variations within the scope of the invention are possible in light of the above teaching. It is intended that the scope of the invention encompass the generic area as herein disclosed, and by the claims appended hereto and their equivalents.

1. A medical information patch comprising a substrate having a first surface printed with medical information and a second surface comprising an adhesive for adhering the patch to the skin of a person.

2. The medical information patch of claim 1, wherein the substrate is flexible.

3. The medical information patch of claim 1 in which the medical information is a universal symbol indicating the person has a medical condition.

4. The medical information patch of claim 3 in which the universal symbol indicates a specific medical condition.

5. The medical information patch of claim 1, which further comprises means for carrying a supply of a medicament of the person.

6. The medical information patch of claim 1, which further comprises a memory chip storing medical information of the person readable by an electronic reader.

7. The medical information patch of claim 1, which further comprises a device for monitoring medical conditions of the person.

8. The medical information patch of claim 1, wherein the adhesive comprises a pressure sensitive adhesive.

9. The medical information patch of claim 1, which further comprises a release liner releasably secured to the second surface of the substrate.

10. The medical information patch of claim 1, which further comprises a protective cover that is permanently or releasably secured to the first surface of the substrate.

11. The medical information patch of claim 10, wherein the protective cover is printed with medical information.

12. The medical information patch of claim 10, which further comprises additional information disposed between the protective cover and the first surface.

13. The medical information patch of claim 12 in which the additional information comprises emergency instructions specific for the person.

14. The medical information patch of claim 12 in which the additional information comprises emergency contact information for the person.

15. The medical information patch of claim 12 in which the additional information is contained on paper.

16. The medical information patch of claim 12 in which the additional information is contained on a computer-readable memory chip.

17. The medical information patch of claim 12 which further includes an emergency supply of medication disposed between the protective cover and the first surface.

18. A medical information patch comprising:
a substrate having a first surface printed with medical information and a second surface comprising an adhesive for adhering the patch to the skin of a person;
a release liner releasably secured to the second surface of the substrate, which when removed, uncovers the adhesive on the second surface; and
a protective cover releasably secured to the first surface of the substrate.
